(19) United States
(12) Patent Application Publication
(10) Pub. No.: US 2008/0165216 A1
(43) Pub. Date: Jul. 10, 2008

(54) IMAGE FORMING APPARATUS AND METHOD THEREOF

(75) Inventor: Sung Ryul LEE, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/938,944

(22) Filed: Nov. 13, 2007

(30) Foreign Application Priority Data
Jan. 8, 2007 (KR) 2007-2079

(51) Int. Cl. B41J 29/38; H02P 7/00

(52) U.S. Cl. 347/16; 318/638

(57) ABSTRACT

An apparatus to control a velocity of a printing-paper transfer motor which is used in a series of processes of picking up paper loaded in a paper cassette, performing a printing operation and ejecting the paper to the outside of the apparatus. A motion generation unit improves a velocity control command output in a deceleration period of a velocity profile and gains and a constant are tuned at the time of design of a PID controller.

### CROSS-REFERENCE TO RELATED APPLICATIONS

This application claims priority under 35 U.S.C. §119(a) from Korean Patent Application No. 2007-2079, filed on Jan. 8, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus to control a velocity of a DC servo motor used in a paper transferring system to transfer printing paper.

2. Description of the Related Art

In a paper transferring system of a printing device such as an inkjet printer, paper transfer precision is closely associated with printing quality. In order to obtain high printing quality, a high-precision paper transfer control method is required.

The paper transferring method of the printing device includes a series of processes of picking up paper loaded in a paper cassette one sheet by one sheet, performing a printing operation and ejecting the paper to an area outside the printing device. Since the paper is transferred along a transfer path by a transfer unit which receives power from a motor, the paper transfer is significantly influenced by control of the motor.

As illustrated in FIG. 1, in a conventional motor control, a motor velocity S1 is controlled such that the motor velocity S1, which is measured by a velocity sensor (encoder), traces a velocity profile S2 which is previously generated in correspondence with the paper transfer. Accordingly, a position profile S4 induced by the motor velocity S1 also traces a position profile S3 corresponding to the velocity profile S2. Accordingly, the velocity profile S2 includes an acceleration period Ta, an equivelocity period Tf and a deceleration period Td.

However, in actual motor control, an error occurs when the motor velocity S1 traces the velocity profile S2. More specifically, a positional error Pd occurs when a motor position, that is, a position Pa of the transferred paper, does not become a target position Pt even at an end point of the deceleration period Td. Accordingly, the motor position is controlled during a predetermined period Tp until reaching the target position. That is, a conventional velocity controller controls the motor velocity in the acceleration period Ta, the equivelocity period Tf and the deceleration period Td of the velocity profile S2, and a position controller controls the motor velocity in the period Tp in order to compensate for the positional error Pd.

The above motor controlling method has the following problems.

Since the period for controlling the motor velocity using the velocity controller and the period for controlling the motor velocity using the position controller are discontinuous, motion vibration may result and thus an accurate and stable paper transferring operation may not occur. This may further deteriorate printing quality.

In addition, a method of setting a maximum acceleration which is applied in the acceleration period when the velocity profile is designed was not suggested.

Furthermore, when both the velocity controller and the position controller are included, gains of the controllers must be individually set. Accordingly, it takes much time to set optimal gains.

### SUMMARY OF THE INVENTION

The general inventive concept provides an image forming apparatus, including a single velocity controller, to control a velocity of a DC servo motor used in a paper transferring system to transfer printing paper.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an image forming apparatus including a printing device, a paper transferring system which is mounted in the printing device to transfer paper using a DC servo motor, a velocity sensor to measure a velocity of the DC servo motor, a motion generation unit to generate a velocity profile including a plurality of periods to transfer the paper and to output a velocity control command using positional information of the motor in a deceleration period of the velocity profile, and a velocity controller to output a motor control command to control the motor according to the velocity control command of the motion generation unit, the motor control command uses system response characteristics of the paper transferring system.

The motion generation unit may output the velocity control command in the deceleration period by the following equation:

VEL_COMMAND=K*(TARGET_POS−CURRENT_POS) and

K=VEL_CONST/(TARGET_POS−BREAK_POS)

where VEL_COMMAND is the velocity control command in the deceleration period, TARGET_POS is a target control position, CURRENT_POS is a current position, K is a constant, BREAK_POS is a position of the paper at a time point when an equivelocity period is switched to the deceleration period, and VEL_CONST is the velocity in the equivelocity period.

The motion generation unit may output the same velocity control command at an end point of the equivelocity period and a start point of the deceleration period.

The motion generation unit may define a maximum acceleration which is applied in an acceleration period of the velocity profile using motor parameters.

The motion generation unit may define the maximum acceleration by the following equation:

MAX_ACCEL={(Kt*Im}−Tl}/Jt

where, Kt is a torque constant of the motor, Im is maximum current of the motor, Tl is a load torque, and Jt is moment of inertia of the motor.

The velocity controller may output the motor control command in consideration of gains of the controller and a constant for load friction.

The velocity controller may output the motor control command by the following equation:

U(t)=Kp{yc(t)−y(t)}+Ki∫{yc(t)−y(t)}dt−Uff

where, U(t) is the motor control command, Kp is a proportional gain, Ki is an integral gain, and Uff is a constant to compensate the load friction.

The velocity controller may determine the gains and the constant corresponding to the load friction using the following equation which approximates an output of the paper transferring system using the DC motor to a primary equation:

Y(s)={Kdc/(Ts+1)}*{U(s)+d(s)}

where, U(s) is a system input, d(s) is disturbance, Y(s) is the velocity, Kdc is a DC gain of the system, and T is a time constant.

The velocity controller may determine the proportional gain Kp and the integral gain Ki of the controller by applying the DC gain Kdc of the system and the disturbance to a pole placement method and determine the constant Uff by the estimated disturbance d.

The foregoing and/or other aspects and utilities of the present general inventive concept may also be achieved by providing an image forming apparatus including a printing device, a paper transferring system which is mounted in the printing device to transfer paper using a DC servo motor, a velocity sensor to measure a velocity of the DC servo motor, a motion generation unit to generate a velocity profile including a plurality of periods to transfer the paper and outputs a same velocity control command at an end point of an equivelocity period and a start point of a deceleration period, a subtracter to supply an error signal by subtraction between the velocity control command of the motion generation unit and the motor velocity of the velocity sensor, a velocity controller to output a motor control command using the error signal supplied from the subtracter, a proportional gain, an integral gain and a constant for load friction, and a PWM driver to output a PWM signal to drive the motor of the paper transferring system according to the motor control command of the velocity controller.

The velocity controller may tune the proportional gain, the integral gain and the constant for the load friction using an equation model which approximates an output of the paper transferring system using the DC servo motor by a primary equation.

The foregoing and/or other aspects and utilities of the present general inventive concept may also be achieved by providing an image forming apparatus, including a paper transferring system to transfer paper using a DC servo motor, a velocity sensor to measure a velocity of the DC servo motor, a motion generation unit to output a velocity control command using positional information of the DC servo motor, and a velocity controller to output a motor control command to control the DC servo motor according to the velocity control command of the motion generation unit.

The motor control command may use system response characteristics of the paper transferring system to control the DC servo motor.

The motion generation unit may generate a velocity profile including a plurality of periods.

The motion generation unit may transfer the paper in a deceleration period of the velocity profile.

The velocity controller may output the DC servo motor control command in consideration of gains of the velocity controller and a constant corresponding to load friction.

The foregoing and/or other aspects and utilities of the present general inventive concept may also be achieved by providing a method of an image forming apparatus, the method including transferring paper using a DC servo motor; measuring a velocity of the DC servo motor, generating a velocity profile including a plurality of periods to transfer the paper and to output a velocity control command using positional information of the DC servo motor in a deceleration period of the velocity profile, and outputting a motor control command to control the DC servo motor according to the velocity control command of the motion generation unit, wherein the motor control command uses system response characteristics of the paper transferring system.

The velocity control command may be output in the deceleration period by an equation as follows:

VEL_COMMAND=K*(TARGET_POS−CURRENT_POS) and

K=VEL_CONST/(TARGET_POS−BREAK_POS),

where, VEL_COMMAND is the velocity control command in the deceleration period, TARGET_POS is a target control position, CURRENT_POS is a current position, K is a constant, BREAK_POS is a position of the paper at a time point when an equivelocity period is switched to the deceleration period, and VEL_CONST represents velocity in the equivelocity period.

The foregoing and/or other aspects and utilities of the present general inventive concept may also be achieved by providing a method of an image forming apparatus, the method including a transferring paper using a DC servo motor, measuring a velocity of the DC servo motor, generating a velocity profile including a plurality of periods to transfer the paper, outputting a same velocity control command at an end point of an equivelocity period and a start point of a deceleration period, supplying an error signal by subtraction between the velocity control command of the and the motor velocity, outputting a motor control command using the error signal, a proportional gain, an integral gain and a constant corresponding to load friction, and outputting a PWM signal to drive the DC servo motor of the paper transferring system according to the motor control command.

The foregoing and/or other aspects and utilities of the present general inventive concept may also be achieved by providing a method of an image forming apparatus, the method including transferring paper using a DC servo motor, measuring a velocity of the DC servo motor, outputting a velocity control command using positional information of the DC servo motor, and outputting a motor control command to control the DC servo motor according to the velocity control command of the motion generation unit.

The foregoing and/or other aspects and utilities of the present general inventive concept may also be achieved by providing an image forming apparatus, including a printing device, a paper transferring system to transfer paper to the printing device, and a unit to control the paper transfer system according to a velocity profile and a velocity of the paper transferring system.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating a velocity profile and a position profile to control a motor to transfer printing paper;

FIG. 2A is a block diagram illustrating a configuration of an image forming apparatus according to the present general inventive concept;

FIG. 2B is a block diagram showing illustrating a control unit of an image forming apparatus according to the present general inventive concept;

FIG. 3 is a velocity profile generated by a motion generation unit according to the present general inventive concept;

FIG. 4 is a view illustrating an input pulse applied to a paper transferring system when a controller according to the present general inventive concept is designed;

FIG. 5 is a view illustrating an output waveform of the system corresponding to the input pulse illustrated in FIG. 4;

FIG. 6 is a view illustrating a curve fitting method applied to the present general inventive concept based on the input pulse of FIG. 4 and the output waveform of FIG. 5 of the paper transferring system;

FIG. 7 is a velocity graph of a simulation result according to the present general inventive concept;

FIG. 8 is a position graph of the simulation result according to the present general inventive concept; and

FIG. 9 is a flowchart illustrating a method of controlling an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The image forming apparatus according to the present embodiment controls a DC servo motor used in a paper transferring system of a printing device. The DC servo motor is associated with a series of processes of picking up paper loaded in a paper cassette, performing a printing operation and ejecting the paper to an area outside of the apparatus.

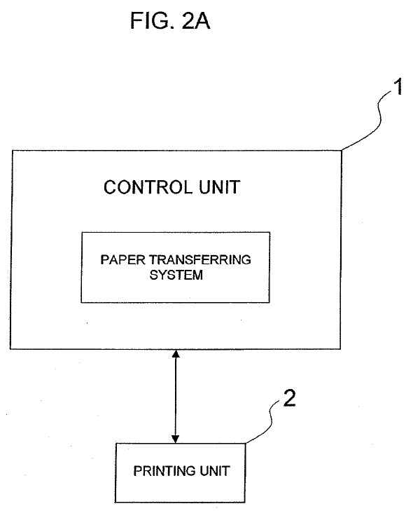

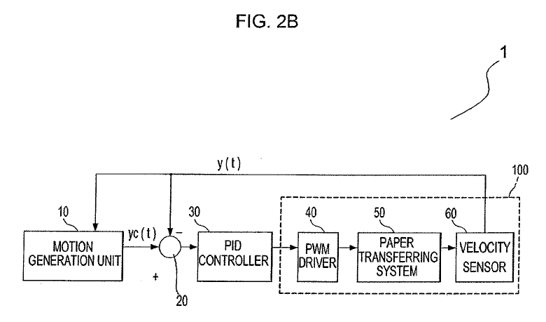

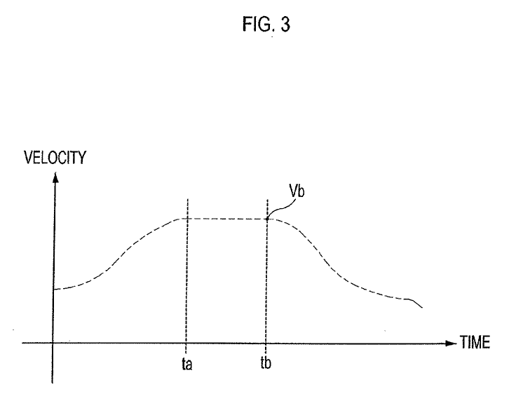

As illustrated in FIG. 2A, the image forming apparatus according to the present general inventive concept includes a control unit 1 to control a paper transferring unit 50 to transfer paper, and a printing unit 2 to print an image on the transferred paper. As illustrated in FIG. 3B, the control unit 1 includes a motion generation unit 10, a subtracter 20, a PID controller 30, a PWM driver 40, a paper transferring system 50, and a velocity sensor 60. The PWM driver 40, the paper transferring system 50 and the velocity sensor 60 are defined as a motor modeling unit 100 to design the PID controller 30.

The motion generation unit 10 generates a velocity profile to transfer the paper and outputs a velocity control command yc(t) to allow a measured motor velocity y(t) to trace the velocity profile.

The subtracter 20 outputs an error signal by subtraction between the velocity control command yc(t) and the motor velocity y(t).

The PID controller 30 applies a proportional gain, an integral gain and a differential gain to the output of the subtracter 20 and outputs a motor control command to the motor modeling unit 100. The PID controller 30 may be replaced with a PI controller according to a design of the image forming apparatus.

The PWM driver 40 supplies a PWM signal which drives a motor to transfer the printing paper to the paper transferring system 50 according to the output of the PID controller 30. Accordingly, the paper transferring system 50 picks up the paper loaded in the paper cassette and transfers the paper along a paper transferring path. Subsequently, the velocity sensor 60 measures the motor velocity and feeds back the measured motor velocity y(t) to the motion generation unit 10 and the subtracter 20.

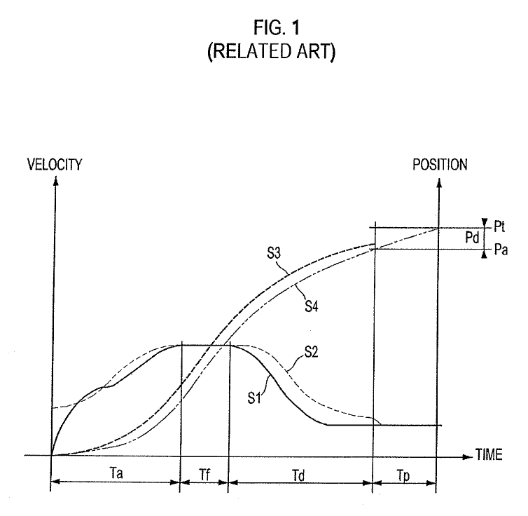

A method of allowing the PID controller 30 to receive an error signal between the motor velocity and the velocity control command and to output the motor control command is also used in the conventional motor control method of FIG. 1. However, when only the error signal is used, the position precision in the deceleration period of the velocity profile deteriorates and thus a positional error may occur.

Furthermore, when a position controller is used to solve a problem due to the positional error, a variety of complications may arise. Accordingly, a method of solving the problem due to the positional error without using a position controller is required.

In order to solve the problem due to the positional error, the motion generation unit 10 according to the present general inventive concept improves the velocity control command output in the deceleration period of the velocity profile, and the gains and a constant are tuned when the PID controller 30 is designed.

The motion generation unit 10 outputs the velocity control command according to the velocity profile having an acceleration period, an equivelocity period and the deceleration period illustrated in FIG. 3.

The motion generation unit 10 defines a maximum acceleration MAX_ACCEL used in the acceleration period using motor parameters as follow.

MAX_ACCEL={(Kt*Im}−Tl}/Jt [EQUATION 1]

where, Kt is a torque constant of the motor, Im is maximum current of the motor, Tl is a load torque, and Jt is moment of inertia of the motor.

The motion generation unit 10 receives the error signal between the motor velocity and the velocity control command in the acceleration period and the equivelocity period which is a period of time defined by time points ta and tb, and outputs the motor control command. Since the position precision may deteriorate in the deceleration period, the motion generation unit 10 generates and outputs the following velocity control command VEL_COMMAND.

VEL_COMMAND=K*(TARGET_POS−CURRENT_POS) [EQUATION 2]

where, VEL_COMMAND is the velocity control command in the deceleration period, TARGET_POS is a target control position, CURRENT_POS is a current position, and K is a constant.

K=VEL_CONST/(TARGET_POS−BREAK_POS) [EQUATION 3]

where, BREAK_POS is a position of the paper at a time point when the equivelocity period is switched to the deceleration period and VEL_CONST is the velocity in the equivelocity period, which is a value set at the time of the design.

The velocity control command vb at the time point when the equivelocity period is switched to the deceleration period can be represented by the following equation.

Vb={VEL_CONST/(TARGET_POS−BREAK_POS)}*(TARGET_POS−CURRENT_POS) [EQUATION 4]

Since (TARGET_POS−BREAK_POS) and (TARGET_POS−CURRENT_POS) are equal at the time point tb, the velocity control command vb becomes the velocity VEL_CONST of the equivelocity period, and thus, the velocity control commands at an end point of the equivelocity period and a start point of the deceleration period are equal.

The PID controller 30 which receives the velocity control command needs to tune the gains and the constant with respect to the motor modeling unit 100 to prevent the positional error from occurring during the deceleration period.

Now, an operation of tuning the gains and the constant with respect to the motor modeling unit 100 will be described.

The motor control command U(t) output from the PID controller 30 can be represented by the following equation.

U(t)=Kp{yc(t)−y(t)}+Ki∫{yc(t)−y(t)}dt−Uff [EQUATION 5]

where, Kp is the proportional gain, Ki is the integral gain, and Uff is a constant to compensate load friction. The PID controller 30 according to the present embodiment functions as a PI controller using the proportional gain Kp and the integral gain Ki.

In order to automatically tune the proportional gain Kp, the integral gain Ki and the constant Uff, an equation model which approximates an output of the paper transferring system 50 is introduced.

When a DC motor to transfer the paper is used, the system output Y(s) of the paper transferring system 50 is approximated to the following primary equation model.

Y(s)={Kdc/(Ts+1)}*{U(s)+d(s)} [EQUATION 6]

where, U(s) is a system input, d(s) is disturbance, Y(s) represents velocity, Kdc is a DC gain of the system, and T is a time constant.

A test input signal is input to the system and the time constant T is estimated from the output waveform of the system. At the time of a DC input, Equation 6 can be expressed by Equation 7.

Yss=Kdc*U+Kdc*d [EQUATION 7]

where, Yss is a steady state value of a system response corresponding to the test input signal.

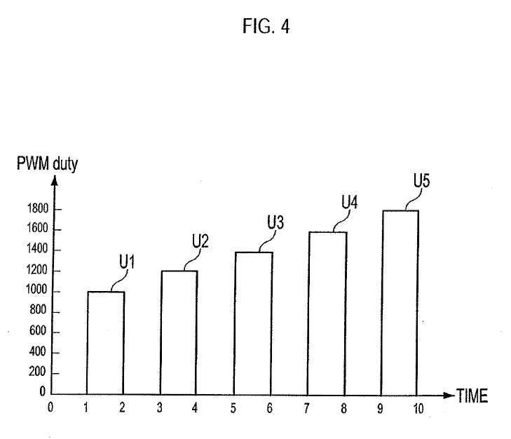

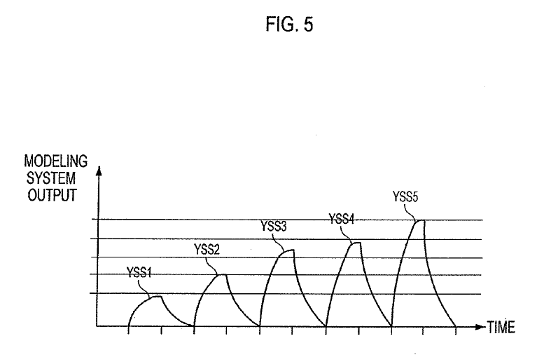

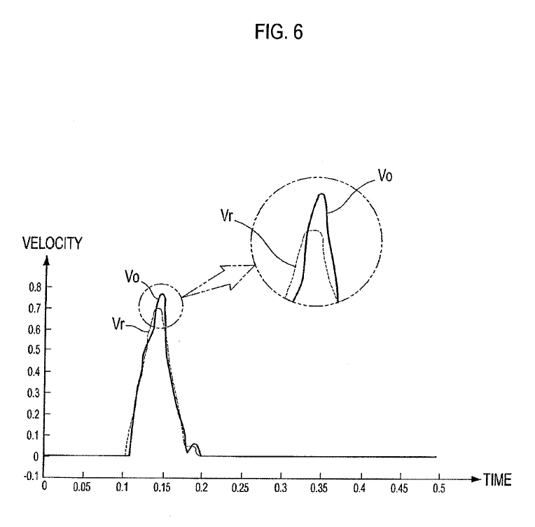

For example, as illustrated in FIG. 4, when the PWM driver 40 supplies test input signals U1, U2, U3, U4 and U5 to the paper transferring system 50 such that output waveforms Yss1, Yss2, Yss3, Yss4 and Yss5 illustrated FIG. 5 are obtained, a straight line of a primary equation illustrated in FIG. 6 is obtained. The DC gain Kdc of the system and the disturbance d can be estimated by comparing straight lines generated by Equation 6 and Equation 7.

The proportional gain Kp and the integral gain Ki of the PID controller 30 are determined by applying the estimated system models to a pole placement method. The constant Uff is determined by the estimated disturbance d.

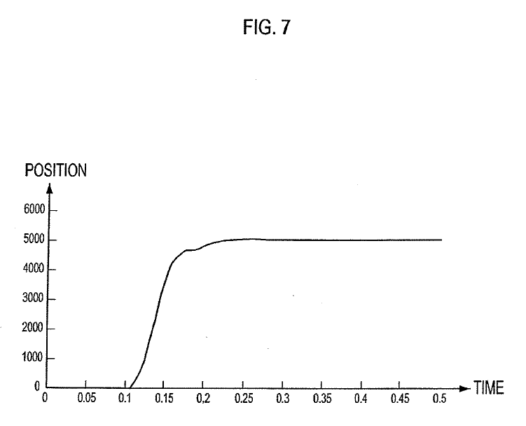

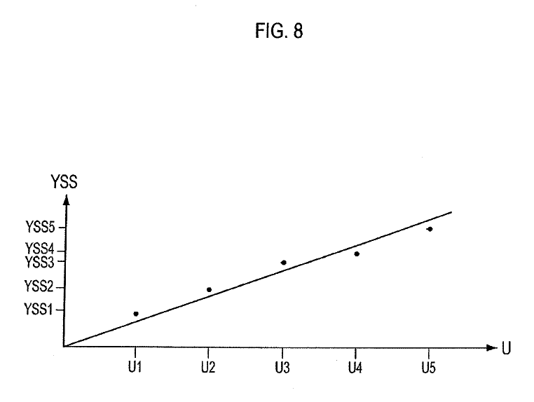

As a simulation result using the improved motion generation unit 10 and the PID controller 30, only a small difference occurs between a reference signal Vr and an actual output Vo and the velocity traces the velocity profile excellently as illustrated in the velocity graph of FIG. 7. Accordingly, as illustrated in the position graph of FIG. 8, it can be seen that the paper can be accurately transferred to a target position.

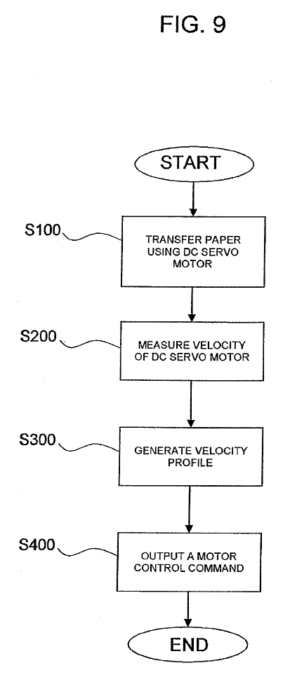

FIG. 9 is a flowchart illustrating a method of controlling an image forming apparatus according to an embodiment of the present general inventive concept. In operation S100, a DC servo motor transfers a paper. In operation S200, a velocity of the DC servo motor is measured. In operation S300, a velocity profile is measured, including a plurality of periods to transfer the paper and to output a velocity control command using positional information of the DC servo motor in a deceleration period of the velocity profile. In operation S400, a motor control command is output to control the DC servo motor according to the velocity control command of the motion generation unit, and the motor control command uses system response characteristics of the paper transferring system.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to the present general inventive concept, it is possible to prevent position precision from deteriorating in a deceleration period of a velocity profile, even when using only a velocity controller to control a motor velocity according to the velocity profile. In addition, it is possible to solve a problem which is caused when both the velocity controller and a position controller are included.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. An image forming apparatus, comprising:
a printing device;
a paper transferring system mounted in the printing device to transfer paper using a DC servo motor;
a velocity sensor to measure a velocity of the DC servo motor;
a motion generation unit to generate a velocity profile including a plurality of periods to transfer the paper and to output a velocity control command using positional information of the DC servo motor in a deceleration period of the velocity profile; and
a velocity controller to output a motor control command to control the DC servo motor according to the velocity control command of the motion generation unit, wherein the motor control command uses system response characteristics of the paper transferring system.

2. The image forming apparatus according to claim 1, wherein the motion generation unit outputs the velocity control command in the deceleration period by an equation as follows:
VEL_COMMAND=K*(TARGET_POS−CURRENT_POS) and
K=VEL_CONST/(TARGET_POS−BREAK_POS),
where, VEL_COMMAND is the velocity control command in the deceleration period, TARGET_POS is a target control position, CURRENT_POS is a current position, K is a constant, BREAK_POS is a position of the paper at a time point when an equivelocity period is switched to the deceleration period, and VEL_CONST represents velocity in the equivelocity period.

3. The image forming apparatus according to claim 2, wherein the motion generation unit outputs the same velocity control command at an end point of the equivelocity period and a start point of the deceleration period.

4. The image forming apparatus according to claim 1, wherein the motion generation unit defines a maximum acceleration which is applied in an acceleration period of the velocity profile using motor parameters.

5. The image forming apparatus according to claim 4, wherein the motion generation unit defines the maximum acceleration by an equation as follows:
MAX_ACCEL={(Kt*Im}−Tl/}Jt
where, Kt is a torque constant of the DC servo motor, Im is maximum current of the DC servo motor, Tl is a load torque, and Jt is moment of inertia of the DC servo motor.

6. The image forming apparatus according to claim 1, wherein the velocity controller outputs the DC servo motor control command in consideration of gains of the velocity controller and a constant corresponding to load friction.

7. The image forming apparatus according to claim 6, wherein the velocity controller outputs the motor control command by an equation as follows:
U(t)=Kp{yc(t)−y(t)}+Ki∫{yc(t)−y(t)}dt−Uff
where, U(t) is the motor control command, Kp is a proportional gain, Ki is an integral gain, and Uff is a constant to compensate the load friction.

8. The image forming apparatus according to claim 7, wherein the velocity controller determines the gains and the constant corresponding to the load friction using an equation to approximate an output of the paper transferring system using the DC servo motor to a primary equation:
Y(s)={Kdc/(Ts+1)}*{U(s)+d(s)}
where, U(s) is a system input, d(s) is disturbance, Y(s) is the velocity, Kdc is a DC gain of the system, and T is a time constant.

9. The image forming apparatus according to claim 8, wherein the velocity controller determines the proportional gain Kp and the integral gain Ki of the controller by applying the DC gain Kdc of the system and the disturbance d to a pole placement method and determines the constant Uff by the estimated disturbance d.

10. An image forming apparatus, comprising:
a printing device;
a paper transferring system mounted in the printing device to transfer paper using a DC servo motor;
a velocity sensor to measure a velocity of the DC servo motor;
a motion generation unit to generate a velocity profile including a plurality of periods to transfer the paper and to output a same velocity control command at an end point of an equivelocity period and a start point of a deceleration period;
a subtracter to supply an error signal by subtraction between the velocity control command of the motion generation unit and the motor velocity of the velocity sensor;
a velocity controller to output a motor control command using the error signal supplied from the subtracter, a proportional gain, an integral gain and a constant corresponding to load friction; and
a PWM driver to output a PWM signal to drive the DC servo motor of the paper transferring system according to the motor control command of the velocity controller.

11. The image forming apparatus according to claim 10, wherein the velocity controller tunes the proportional gain, the integral gain and the constant corresponding to the load friction using an equation model to approximate an output of the paper transferring system using the DC servo motor by a primary equation.

12. An image forming apparatus, comprising:
a paper transferring system to transfer paper using a DC servo motor;
a velocity sensor to measure a velocity of the DC servo motor;
a motion generation unit to output a velocity control command using positional information of the DC servo motor; and
a velocity controller to output a motor control command to control the DC servo motor according to the velocity control command of the motion generation unit.

13. The image forming apparatus of claim 12, wherein the motor control command uses system response characteristics of the paper transferring system to control the DC servo motor.

14. The image forming apparatus of claim 12, wherein the motion generation unit generates a velocity profile including a plurality of periods.

15. The image forming apparatus of claim 14, wherein the motion generation unit transfers the paper in a deceleration period of the velocity profile.

16. The image forming apparatus of claim 12, wherein the velocity controller outputs the DC servo motor control command in consideration of gains of the velocity controller and a constant corresponding to load friction.

17. A method of an image forming apparatus, the method comprising:
transferring paper using a DC servo motor;
measuring a velocity of the DC servo motor;
generating a velocity profile including a plurality of periods to transfer the paper and to output a velocity control command using positional information of the DC servo motor in a deceleration period of the velocity profile; and
outputting a motor control command to control the DC servo motor according to the velocity control command of the motion generation unit, wherein the motor control command uses system response characteristics of the paper transferring system.

18. The method of claim 17, wherein the velocity control command is output in the deceleration period by an equation as follows:
VEL_COMMAND=K*(TARGET_POS−CURRENT_POS) and
K=VEL_CONST/(TARGET_POS−BREAK_POS),
where, VEL_COMMAND is the velocity control command in the deceleration period, TARGET_POS is a target control position, CURRENT_POS is a current position, K is a constant, BREAK_POS is a position of the paper at a time point when an equivelocity period is switched to the deceleration period, and VEL_CONST represents velocity in the equivelocity period.

19. A method of an image forming apparatus, the method comprising:
a transferring paper using a DC servo motor;
measuring a velocity of the DC servo motor;
generating a velocity profile including a plurality of periods to transfer the paper;
outputting a same velocity control command at an end point of an equivelocity period and a start point of a deceleration period;
supplying an error signal by subtraction between the velocity control command of the and the motor velocity;
outputting a motor control command using the error signal, a proportional gain, an integral gain and a constant corresponding to load friction; and
outputting a PWM signal to drive the DC servo motor of the paper transferring system according to the motor control command.
